(19) United States
(12) Patent Application Publication
(10) Pub. No.: US 2015/0209212 A1
(43) Pub. Date: Jul. 30, 2015

(54) METHOD AND APPARATUS FOR TREATING, ASSESSING AND/OR DIAGNOSING BALANCE DISORDERS USING A CONTROL MOMENT GYROSCOPIC PERTURBATION DEVICE

(71) Applicant: James R. Duguid, Indianapolis, IN (US)

(72) Inventor: James R. Duguid, Indianapolis, IN (US)

(21) Appl. No.: 14/680,558

(22) Filed: Apr. 7, 2015

Related U.S. Application Data
(63) Continuation-in-part of application No. 14/026,590, filed on Sep. 13, 2013.
(60) Provisional application No. 61/976,214, filed on Apr. 7, 2014.
(60) Provisional application No. 61/701,302, filed on Sep. 14, 2012.

(51) Int. Cl. A61H 1/00; A61H 3/00

(52) U.S. Cl. CPC A61H 1/001; A61H 3/00; A61H 2201/5007; A61H 2201/1652; A61H 2203/0406; A61H 2201/1628; A61H 2201/5097; A61H 2201/1215; A61H 2201/5069

(57) ABSTRACT

A method and apparatus for controlling a wearable control momentum gyroscopic stabilization device for diagnosing, treating, and/or assisting subjects who suffer from a balance disorder. The device can be configured for balance diagnosis assessment and/or physical therapy to produce one or a series of torques in a direction that cause a subject to become imbalanced and could be controlled through automated sensors, a preset program, or controls operated by either the subject or an individual supervising of a balance therapy exercise.

### CROSS-REFERENCE TO RELATED APPLICATION

This application is a continuation-in-part of U.S. application Ser. No. 14/026,590 filed Sep. 13, 2013, which claims the benefit of U.S. Application No. 61/701,302 filed Sep. 14, 2012, and this application also claims the benefit of U.S. Application No. 61/976,214 filed Apr. 7, 2014, all of which are hereby incorporated by reference.

### BACKGROUND

This disclosure relates generally to perturbation methods and devices for the treatment of balance disorders.

The loss of the sense of balance can be a very debilitating prospect for a person. The sense of balance is essential for carrying out most day to day activities including movement, operation of physical equipment, and the ability to operate a motor vehicle. A person who loses their sense of balance may become immobile, suffer from severe headaches, be incapable of holding a job, and may generally be unable to function as a member of society.

Balance disorders (such as vertigo) can take many forms. Temporary loss of balance can be the result of a sudden force acting upon the inner ear of a person. Temporary loss of balance is a common ailment of persons who have survived auto wrecks. Sustained loss of balance can occur from several conditions including physical ailments of the inner ear, Parkinson's disease, and a variety of vestibular disorders. Neurological disorders and even psychological disorders can also result in a loss of balance. The elderly are particularly susceptible to permanent, debilitating loss of balance. As a result, falls due to loss of balance are currently the most common cause of emergency department visits by elderly adults and the leading cause of both fatal and nonfatal injuries for the elderly.

In recent years, one technique for treating balance disorders that has seen particular success and attention is Perturbation-Based Balance Training (PBBT). PBBT aims to improve the balance and agility of an individual as well as to assess and study posturography. PBBT therapy involves exposing patients to various destabilizing forces in situations that challenge and eventually strengthen an individual's balance ability.

The most basic form of PBBT involves the manual generation of a perturbation force upon a patient. This force can be generated from a manual push or pull by the therapist. Disadvantageously, the manual methods are inexact and difficult to regulate and/or quantify practically. The same therapist may inflict different magnitudes or directions of force depending on person preference or the same therapist may inadvertently vary the forces in a same session or different sessions between the same or different patients. Additionally, the manual generation of the force can divert the therapist's attention away from the analysis and assessment of the subject as the subject reacts to the forces.

A variation of the manual application of force for PBBT is the use of the Repeated Incremental Predictable Perturbation in Standing (RIPPS) technique. The RIPPS technique involves a therapist pulling on the subject's body to generate a perturbation force with the use of a spring scale. The spring scale can be used to quantify the perturbing force, aiding in reproducibility. This method has limitations in that the subject must remain stationary during the application of the force. Additionally, this method is ill suited for the application of more complex, dynamic forms of movement and locomotion that may be advantageous for comprehensive balance therapy.

Another class of PBBT techniques and devices focus on the use of support platforms on which the patient stands. The platforms can take the form of roller boards, tilt boards, foam pads, and can be manually or mechanically moved. The manual methods of actuation of the platforms, similar to other manual techniques, are difficult to regulate and quantify. The mechanically motivated platforms are in improvement over manual actuation, in this respect, but still have drawbacks. For example, the platforms are stationary and cannot directly induce perturbation forces into the upper body of the patient which the patient may be subject to through normal daily activities.

Most of these platforms also do not enable the user to perform the motions of walking, running, or the like. The platforms are generally limited to treating a stationary patient. One exception is the Balance Measure & Perturbation (BaMPer) system which used a moving treadmill wherein the treadmill surface is able to be shifted and tilted. However, the BaMPer system is difficult to transport, relatively expensive, and only allows movement in a linear direction. The BaMPer system does not allow the patient to be subjected to the turning and twisting forces that a patient would be subjected to from navigating obstacles that that the patient may be subjected to during day to day activities. The linear motion thus limits the forces that the patient can be subjected to for treatment of the balance disorder.

Still another device for aiding in the application of PBBT is the Portable and Automated Postural Perturbation System (PAPPS). The PAPPS system consists of a series of metal frames that surround the subject and deliver perturbation forces through the use of linear actuators and/or steel cables connected to the patient by a vest. The PAPPS system is portable in the sense that it can be relocated, but the linear actuators must be mounted to a stationary mount with respect to the patient. Therefore, the PAPPS frame cannot move with the patient. Additionally, the PAPPS device is large, is limited in the direction of forces that can be applied, and significantly limits the patient's range of motion as well as the types of exercises that can practically be applied.

Finally, the KineAssist is another device designed to aid in PBBT. The KineAssist consists of a large, wheeled base supporting a robot arm. The robotic arm holds the patient with torso and pelvic harnesses. The wheeled base can include motors such that it can move with the patient. However, the KineAssist must have relatively large mass to be able to support the patient, making the assembly unwieldy and relatively expensive. It is also inappropriate for movement based exercises and is more suited to standing or stepping training. The response time of the large, robotic arm can also impede the use of the KineAssist to practically treat balance disorders through PBBT.

Thus, there is a need for improvement in this field.

### SUMMARY

It is an objective of the present disclosure that a destabilizing, perturbation force may be created, directed, and controlled using a wearable device in order to improve an individual's ability to balance. This may be achieved through the use of a type of gyroscope, known as a control moment gyroscope (CMG). A CMG is an attitude control device that has recently found practical use in spacecraft attitude control systems such as for controlling satellite orientation in outer space. A CMG consists of a spinning rotor and one or more motorized gimbals that tilt the rotor's angular momentum. As the rotor tilts, the changing angular momentum causes a gyroscopic torque that rotates the target body. A CMG uses gyroscopic forces to produce forces in one or more axes. Beneficially, CMGs are compact and able to produce forces in various directions. Additionally, the magnitude of the force can be altered by changing the speed of rotation of the gyroscope. As used herein, the term “perturbation” means “an unconscious reaction to a sudden unexpected out side force or movement.” As used herein, the term “balance” means “a conscious effort to hold a position without falling.”

In the present disclosure, forces produced by one or more relatively small CMGs integrated into a controllable user wearable device are used to disrupt a subject's state of balance as part of a physical therapy program such as Perturbation-Based Balance Training. Additionally, the forces can be used to diagnose balance disorders in patients. The result is a mobile, relatively light weight and relatively low cost perturbation aid that can be worn by the patient during, for example, dynamic movements.

Further forms, objects, features, aspects, benefits, advantages, and embodiments of the present invention will become apparent from a detailed description and drawings provided herewith.

### BRIEF DESCRIPTION OF THE DRAWINGS

FIGS. 1a-c, respectively, shows a human body wearing a device according to one embodiment of the present disclosure and alternate layouts of the device including its core components.

FIGS. 2a and 2b, respectively depict an illustration of a human body's sagittal and coronal axes and how they relate to body motion.

FIGS. 3a and 3b are diagrams illustrating the force of the torque produced against the direction of a fall of a body using the device of the present disclosure.

FIG. 4 illustrates a flow diagram pertaining to the operation of the device of FIG. 1b or 1 c.

FIG. 5 illustrates a patient wearing the device of FIGS. 1a-c used in conjunction with a controller.

FIG. 6 illustrates a gyroscopic rotor with braking mechanism for use with the devices of FIGS. 1a-1c.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

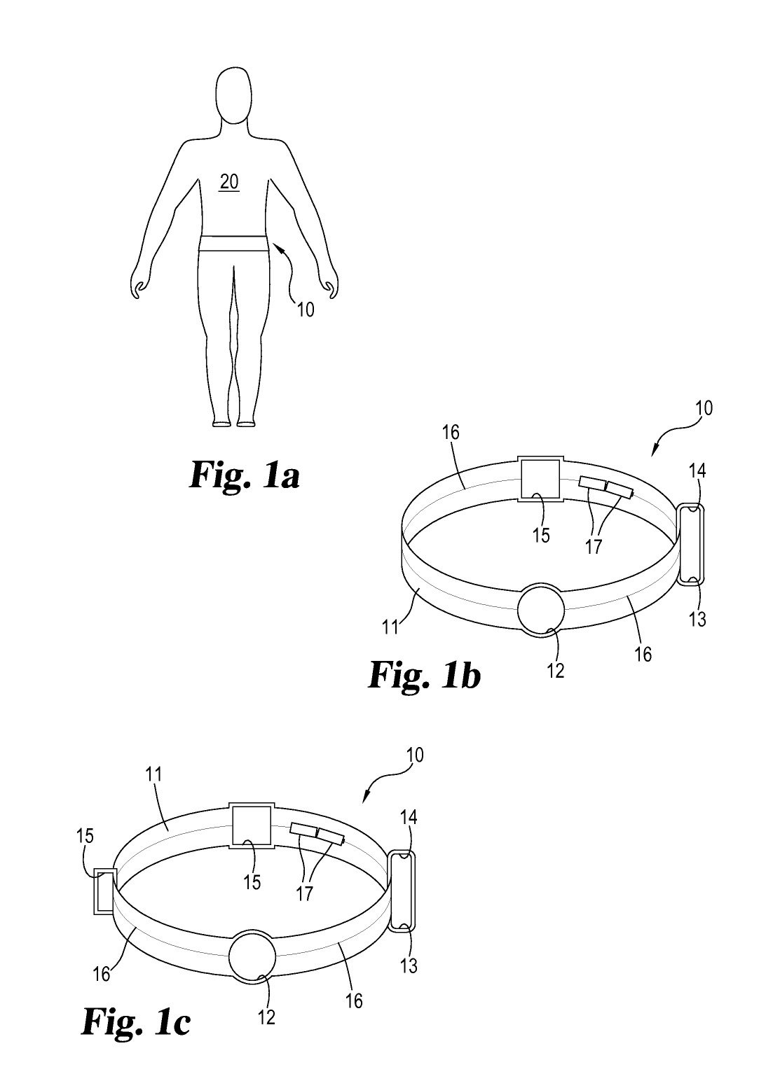

The basic core components of a CMG balance device 10 generally include a wearable belt or harness 11 with an attached, integrated sensing system 12, processing system 13, one or more small control moment gyroscopes (CMGs) 15, and connective wires 16. The CMG balance device 10 may also include one or more rechargeable batteries 17 for providing the necessary electric power requirements. A layout of the CMG balance device 10 and its core components can be seen in FIG. 1. The CMG balance device 10 relies on the interworking of these components for operation.

There are many possible ways to configure the basic elements of the device 10. For example, the sensing system 12 may consist of one or more linear and/or angular motion sensors such as small micro-mechanical accelerometers or gyroscopes that measure motion in one or more axes. These can be attached in multiple locations on the belt or harness 11 so they can best sense a subject's orientation, state of balance, and/or movement. Additionally, they may be placed on additional parts of the body apart from the harness or belt 11 but still connected to the processor 14 with connective wires or a form of wireless communication such as infrared technology. The processor 14 can be mounted on the belt or harness 11 in multiple locations, and can be pre-programmed with computer code appropriate to the particular arrangement. The processor 14 can also be configured to accept commands from the subject or from a supervising individual using wired or wireless controllers such as push buttons or joysticks.

One or more CMGs 15 can be attached to the belt or harness 11 in multiple locations that maximize the effectiveness of the torque produced. Either single or dual-gimbal CMGs may be used, as well as fixed or variable speed CMGs. One example of a CMG such as would be suitable for this purpose is described in detail in U.S. Pat. No. 7,997,157 issued to Smith, et al., which disclosure is hereby expressly incorporated herein. Another CMG of a type suitable for use in the device of the present disclosure is a model produced by Honeybee Robotics of New York, N.Y. named “Tiny Operationally Responsive CMG (TORC),” which can be seen on their website at http://www.honeybeerobotics.com/product-examples/aeromechanical/12-cmg. The belt or harness 11 may constitute a wearable body prosthesis includes that surrounds at least a portion of the torso of the wearer. In one preferred embodiment, the wearable body prosthesis is a belt 11 or harness that surrounds the waist, hips, or trunk of the wearer.

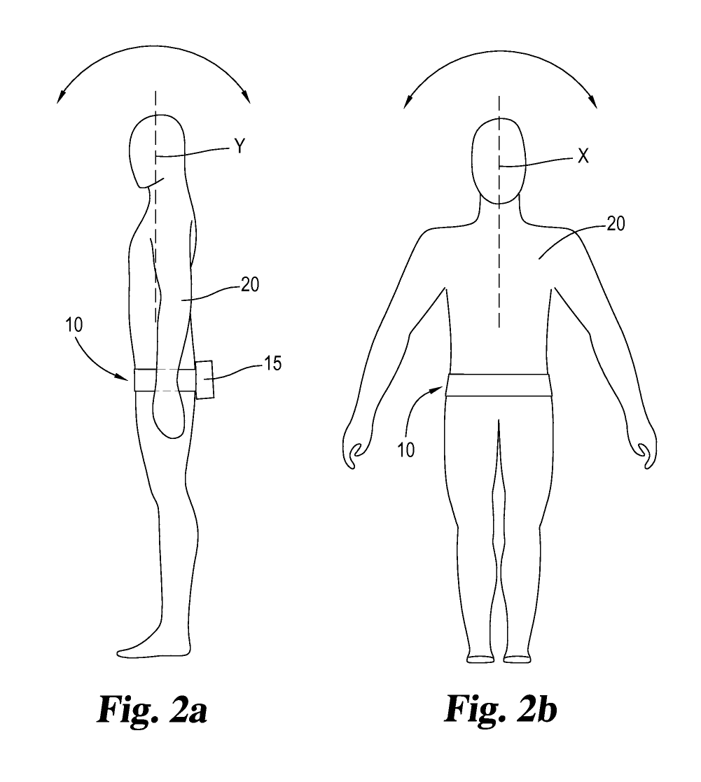

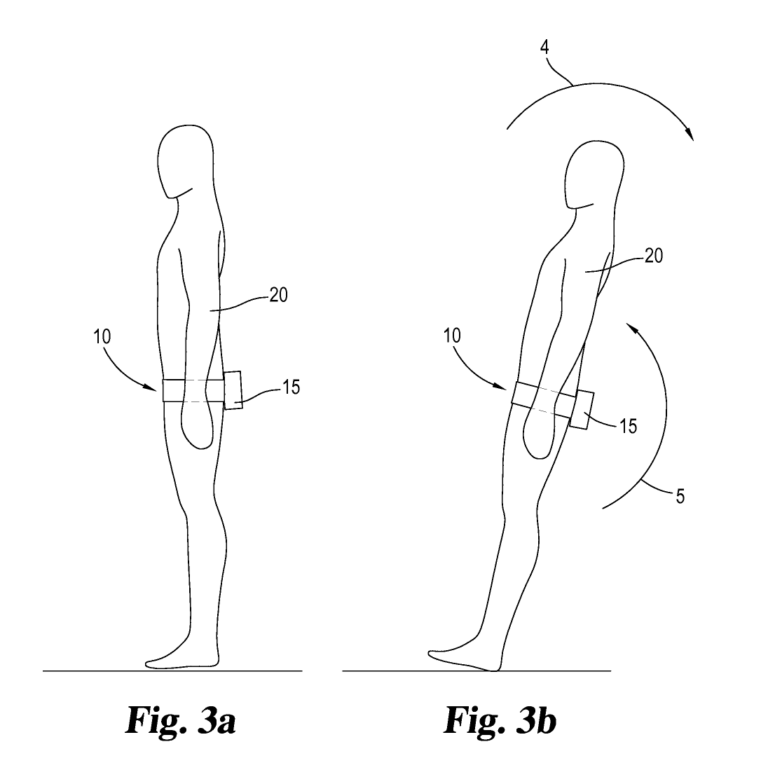

When a standing subject 20 wears the device 10, the sensing system 12 can retrieve information that reflects the body's orientation and motion in both the sagittal and coronal axes. An illustration of these axes and how they relate to body motion can be seen in FIG. 2. Motion in the sagittal plane “X” indicates a fall or imbalance to either the back or front, and motion in the coronal plane “Y” indicates a fall or imbalance to either the left or right. This data can then sent through connective wires to processing system 13, which may for example include a standard computer microprocessor 14 having associated computer processing circuitry and components. Processor 14 can be programmed to read this data and interpret whether the subject is unbalanced, and, if so, in what axis, what direction, and how severely. If the processor 14 can interpret that the subject 20 is falling in a certain direction, it can send signals through connective wires 16 to activate one or more CMGs 15. When activated, the CMG(s) can produce a torque in the same axis but opposite direction of the fall. This results in a force that counteracts the motion of the potential fall. A diagram illustrating the force of this torque produced against the direction of a fall can be seen in FIG. 3. If the fall or imbalance occurs in both the sagittal and coronal axes, multiple CMGs 15 may be activated, or a singular CMG 15 commanded to creat a force with components in both plains. Additionally, the amount of force produced by the CMG(s) 15 may be variable based on the severity of the fall or imbalance.

The counteractive torque of the one or more CMGs 15 can be used to improve the subject's balance through two primary mechanisms. One way this torque improves a subject's balance is by providing a physical, corrective force that acts directly on the body, maintaining and supporting a subject's balanced, upright position. For example, if a person begins to fall backwards the torque of a CMG 15 can be directed to physically “rotate” a subject's body back into balance. The CMG balance device 10 could provide torque to correct potential falls in multiple directions; additionally, the amount of torque provided could be proportional to the severity of the potential fall.

The second way this torque can improve a subject's balance is by providing supplementary sensory feedback, which improves a subject's general awareness of body position and balance. When determining and maintaining balance, a healthy individual integrates feedback from multiple sensory systems including the visual and vestibular systems. When one or more of these systems has been impaired in some way a subject no longer receives the necessary amount of sensory input with which to accurately determine balance, resulting in a balance disorder. However, when physically experiencing the corrective pull and torque of a CMG, a subject is provided with a source of additional, external sensory input in the form of haptic feedback. The subject can use this haptic feedback to better approximate general body orientation and proprioception, ultimately improving the subject's ability to adapt body position to maintain balance.

Another embodiment of the present invention allows it to be used in connection with providing physical therapy and/or diagnosis and assessment of balance disorders. In addition or as an alternative to providing a physically corrective force and supplementary sensory feedback, the device may be configured to intentionally disrupt a subject's state of balance by having the CMG(s) 15 produce a torque in a direction that causes the subject to become imbalanced and thus force the patient to compensate in order to regain balance. A device configured in this way may be used with various forms of physical therapy and/or diagnostic balance assessment that attempt to create similar disruptions in a subject's balance in order to emphasize movement that corrects the imbalance. It is also contemplated that the imbalance routine may be useful for training athletes and/or for certain sports (gymnastics, football, soccer, etc.). The CMG(s) can be controlled by a preset program contained in the memory of the processor 14 or other part of the device, or the CMG(s) can be controlled by an individual supervising the treatment.

When used as a physical therapy device, the disclosed CMG balance device 10 can be configured to provide forces to the subject 20 as part of a physical therapy regiment, such as a PBBT regiment, to improve the subject's balance. The processor 14 can allow an administrator to have manual control over the perturbation forces. Alternatively, the processor 14 can be configured to automatically activated CMG(s) 15 to impart the series of forces optionally in response to the reaction of the patient. The sensing system 12 can be used to gauge the response of the subject 20 to the device 10. In this manner, the series of forces can be adjusted in direction or magnitude in response to the sensor feedback in order to improve the effectiveness of the physical therapy regiment. Alternatively, the administrator may manually gauge the reaction of the patient or use information obtained from the sensing system 12 to gauge the reaction of the patient and adjust the perturbation forces accordingly.

The processor 14 can also be configured to log data from the sensing system 12. The data can include information associated with the patient. The processor 14 can make this information available to remote device. For example, offsite medical providers could access the data from a remote location in order to aid in the diagnosis or treatment of a subject 20.

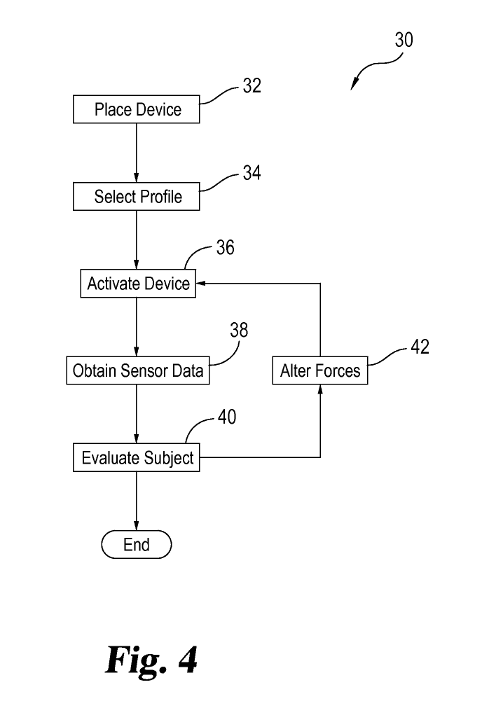

FIG. 4 illustrates an example flow diagram 30 for the operation of the device 10. The flow diagram includes step 32 that can be the placement of the CMG balance device 10 on a subject 20. Optional step 34 can include the selection of a profile of a series of forces that can be stored within the processor 14. The profile can be selected based upon different attributes of the subject 20. Example attributes can include the age weight, or condition of the subject 20. Other example attributes can include the mobility of a subject 20, if, for example, the subject 20 has an immobile or limited mobility extremity. Step 36 can be the activation of one or more forces to cause the subject 20 to become imbalanced. Optional step 38 can include gathering of information from one or more sensors to ascertain the response of the subject 20 to the one or more forces. In step 40, the subject 20 can be evaluated.

Optionally, a feedback step 42 can be included in order to alter the direction, magnitude, frequency, number, other aspects of the forces imparted to the subject 20 during the PBBT regiment used with the device 10. These changes can be used to improve the regiment. For example, a subject 20 who is overly unbalanced from the activation of the CMG balance device 10 may require the force causing the unbalance to be minimized. The minimized force can be a selected force in a particular direction from a series of forces. In this manner, the regiment can be customized to the needs of the user. Conversely, certain forces can be increased in magnitude if the user is not unduly unbalanced by a force. It has also been contemplated that randomized amplitudes and/or directions forces in a series of forces may be beneficial for use with PBBT, as the randomized forces would be unpredictable to the patient. This unpredictability may prevent the patient from anticipating certain forces and may better reflect the forces that the patient would experience in normal day to day activities. The feedback step 42 can also be performed automatically by the processor 14, for example. In this manner, the CMG balance device 10 can be left to perform a physical therapy regiment with minimal operator supervision or intervention.

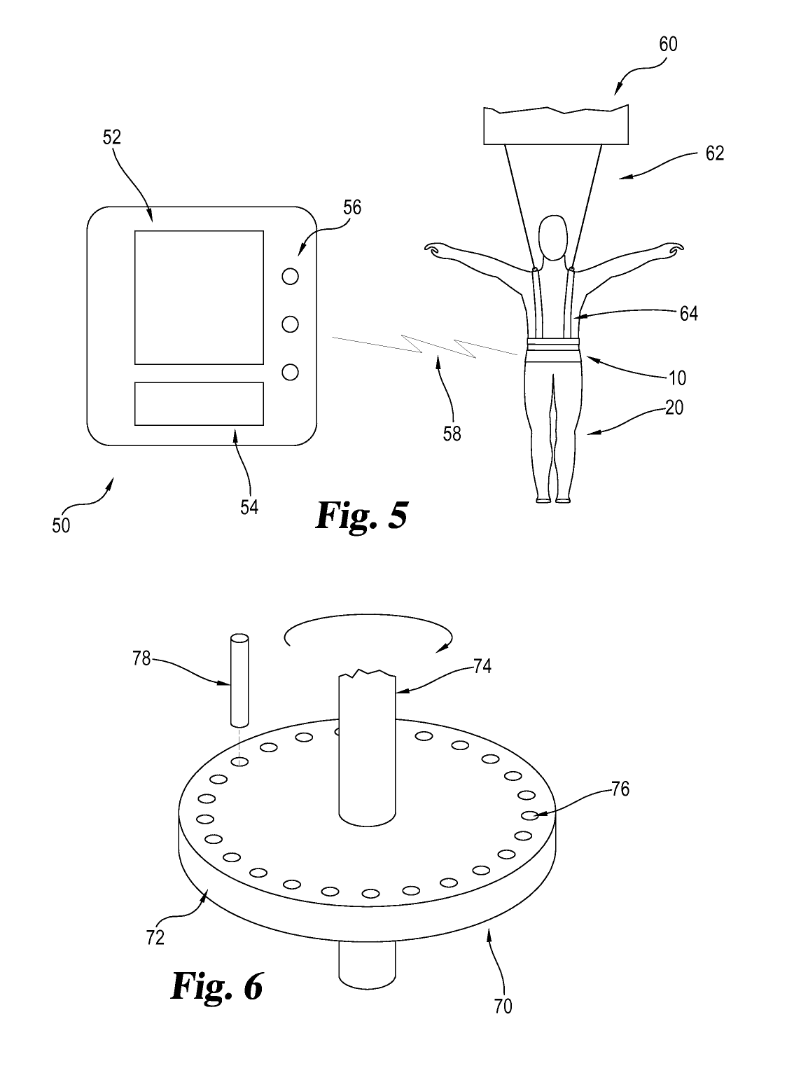

FIG. 5 illustrates the use of a CMG balance device 10 with a subject 20. The subject is illustrated as being secured by a safety harness 62. The safety harness 62 can be used to secure the subject 20 in order to prevent the subject 20 from falling from the use of the CMG balance device 10. The use of the safety harness 62 can increase the safety of the subject 20 during the implementation of a PBBT with the CMG balance device 10. The safety harness 62 is illustrated as including a body fit harness 64 as well as being connected to an overhead support 60 (such as a ceiling or a support frame).

Illustrated is also an example processor 50. The processor 50 can take the form of a control box directly mounted to the CMG balance device 10, a stand alone control device (such as a tablet or computer), or a combination of such devices. The processor 50 can also include a control device such as a joystick or mouse. Illustrated is a touch pad 54 as an input means to the processor 50. The display device 52, touchpad 54, and visual indicator 56 can be integrated into one or more devices such that the input device can also be used to output visual data.

The processor 50 can also include a display device 52 or other visual and/or audio indicators for relaying data pertaining to the use of the device. Illustrated is a light 56 that can be used as a power indicator, an operational indicator, or other. The light 56 can alternatively be a button or an illuminated button. Beyond power and operational indicators, the display device(s)/indicator(s) can be used by an operator to ascertain the current regiment being used with the CMG balance device 10. Alternatively, the display device(s)/indicator(s) can be used to indicate information obtained from the use of the sensing system 12. The display device(s)/indicator(s) can be used by an operator to evaluate the effectiveness of a physical therapy regiment using the CMG balance device 10 via the evaluation of a subject's 20 response to certain forces. Display device(s)/indicator(s) can be remote from or mounted to the device 10.

The processor 50 illustrated includes a wireless interface connection 58 to the CMG balance device 10. The wireless interface connection can be used as a bidirectional link between the processor 50 and CMG balance device 10 to relay commands from the processor and feedback from sensors contained on the CMG balance device 10. Alternative interfaces may be used. A wired connection can be used and can also include a power connection for the CMG balance device 10. An externally provided power source may aid in the safety of the device, enabling the operator to remotely remove power in case of a fault or in case the patient requires assistance. Alternatively, the information link and power link may be separated into any combination of wired or wireless information and/or power transfer.

FIG. 6 illustrates a braking system for a gyroscope 70. Such a braking system can be used with, for example, a CMG 15. Illustrated are a rotor 72 and a spin axis 74. The rotor 72 can include one or more orifices 76. Additionally, the braking system can include a pin 78. The pin 78 can slide through a fixed portion of the CMG 15 assembly (not shown) relative to the rotor. When the pin 78 is inserted into an orifice 76, the rotor can be prevented from spinning. It is contemplated that such a braking device 70 can be beneficial for safety or other purposes. The gyroscope can be prevented from creating an undesirable force upon the subject 20 through the use of the braking device 70.

The braking device 70 can take other forms such as a friction brake acting upon the top, bottom, or sides of the rotor. The braking device 70 can also be electromagnetic in nature to immobilize the rotor 72. The braking device 70 can be manually actuated (by the manual insertion of the pin 78, for example). Alternatively, the brake system 70 can be configured to prevent the rotor 72 from spinning when power is not applied to the CMG 15. The brake system 70 can be actuated via a control device, such as a processor 14. The brake system 70 can be electromagnetically, electromechanically, hydraulically, and/or manually actuated.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A perturbation method of providing physical therapy to improve the balance ability of a subject, comprising the step of directing a CMG mounted to a wearable body prosthesis worn by a subject to produce a perturbation force to cause the subject to become imbalanced, and wherein the perturbation force is used as part of a perturbation based balance training program to improve the balance of the subject by inducing the user to react to the perturbation force.

2. The method of claim 1, wherein the method further comprises the step of evaluating the subject's balance response to the perturbation force.

3. The method of claim 1, wherein the wearable body prosthesis comprises a sensor configured to measure a property correlated with a movement of the subject.

4. The method of claim 3, wherein the method further comprises the step of evaluating the subject's balance response to the perturbation force using data gathered using the sensor.

5. The method of claim 2 wherein a series of perturbation forces are directed to the patient to cause the subject to become imbalanced and wherein the perturbation forces are produced to improve the balance of the subject by inducing the user to react to the perturbation forces.

6. The method of claim 5, wherein the series of perturbation forces are altered over time using information from the evaluation of the subject's balance response.

7. The method of claim 6, wherein perturbation forces of the series of perturbation forces are randomly altered over time in direction and/or magnitude.

8. The method of claim 6, wherein the series of perturbation forces are altered to increase the imbalance induced in the subject over time to treat a diagnosed imbalance disorder.

9. The method of claim 1, wherein the magnitude and or direction of the perturbation force is adjusted depending on the patient's age, mass, or other physical attributes or ailments prior to the inducement of the perturbation force upon the subject.

10. The method of claim 1, wherein the subject is secured by a safety harness to prevent injury to the patient if the patient loses his/her sense of balance and the subject cannot sufficiently recover his/her balance.

11. A perturbation physical therapy and/or diagnostic balance assessment controller, comprising:
a processor configured and arranged to be communicatively coupled to a wearable body prosthesis, the wearable body prosthesis having a control moment gyroscopic stabilization; and
wherein the processor is configured and arranged to command the gyroscope to produce a perturbation force in a direction that would cause a subject wearing the wearable body prosthesis to become imbalanced as part of a perturbation based balance training program.

12. The device of claim 11, wherein the device comprises a neuroplasticity treatment device for treating vertigo or other balance disorders.

13. The device of claim 11, wherein the wearable body prosthesis comprises a single or plurality of CMGs spaced apart around and mounted upon the belt or harness, the processor is communicatively coupled to the plurality of CMGs, and the processor is configured and arranged to command the plurality of CMGs to produce perturbation forces in directions that would cause a subject wearing the wearable body prosthesis to become imbalanced as part of a perturbation based balance training program.

14. The device of claim 11, wherein the processor is configured to store a predefined set of commands to the gyroscopes to mimic a perturbation based balance training program.

15. The device of claim 11, wherein the processor is physically mounted to the wearable prosthesis.

16. The device of claim 12, wherein the processor is configured and arranged to automatically alter a perturbation force provides by one of the gyroscopes using information obtained from a sensor configured and arranged to measure a property correlated with a movement of the subject.

17. A perturbation method of diagnosing balance disorders in a subject, comprising the steps of:
a) activating a CMG of a body prosthesis worn by a subject to produce at least one perturbation force in a direction causing the subject to become imbalanced, the prosthesis having at least one CMG mounted to the prosthesis; and
b) measuring the subject's balance response to the perturbation force produced by the CMG.

18. The method of claim 17, wherein the wearable body prosthesis comprises a sensor configured to measure a property correlated with a movement of the user and wherein measuring the subject's balance response includes data gathered through the use of the sensor.

19. The method of claim 17, wherein multiple perturbation forces are produced in multiple directions or magnitudes.

20. The method of claim 17, wherein the subject is secured by a safety harness to prevent injury to the patient if the patient loses his/her sense of balance and the subject cannot sufficiently recover his/her balance.
